(19) United States
(12) Patent Application Publication
(10) Pub. No.: US 2026/0151289 A1
(43) Pub. Date: Jun. 4, 2026

(54) SHOULDER KNEADING MASSAGE DEVICE AND VEHICLE SEAT

(71) Applicant: Adient (Chongqing) Automotive Components Co., Ltd., Chongqing (CN)

(72) Inventors: Jun XU, Chongqing (CN); Yi XIN, Chongqing (CN); Shaobin XU, Chongqing (CN); Wei JIA, Chongqing (CN); Muxing TAN, Chongqing (CN)

(21) Appl. No.: 19/400,291

(22) Filed: Nov. 25, 2025

(30) Foreign Application Priority Data
Nov. 29, 2024 (CN) 202411736905.5

(51) Int. Cl. A61H 7/00; B60N 2/90

(52) U.S. Cl. CPC A61H 7/007; B60N 2/976; A61H 2201/0149; A61H 2201/1215; A61H 2201/149; A61H 2201/1614; A61H 2203/0431; A61H 2205/062

(57) ABSTRACT

A shoulder kneading massage device may have a shoulder support configured to be disposed at a shoulder position of a seat back. A massage assembly and a driving assembly for driving the massage assembly to move are provided inside the shoulder support. The massage assembly may have a massage head. When the massage head is in contact with a shoulder of an occupant, the driving assembly is able to drive the massage head to reciprocate to simulate kneading massage.

### TECHNICAL FIELD

The device relates to the technical field of vehicle seats, and specifically to a shoulder kneading massage device and to a vehicle seat.

### BACKGROUND ART

To alleviate occupants'fatigue from prolonged sitting and to enhance driving comfort, vehicle seats are typically equipped with massage devices.

Regarding the seat massage function, the mainstream technology involves mounting an airbag inside a vehicle seat back, and achieving the massage effect through the regular inflation and deflation of the airbag. In the prior art, most seats integrate the airbags into the lumbar support area of the backrest and the seat cushion, neglecting the fatigue experienced by the occupants'shoulders. Although a few manufacturers have disposed a massage airbag at the shoulder position of the seat, the overall intensity of airbag massage is low, and the overall comfort of the seat still needs improvement.

### SUMMARY

In view of this, one of the objectives is to provide a shoulder kneading massage device which is intended to effectively relieve the occupants'shoulder fatigue.

To achieve the above objective, the technical solution follows:
A shoulder kneading massage device, comprising a shoulder support configured to be disposed at a shoulder position of a seat back, characterized in that: a massage assembly and a driving assembly for driving the massage assembly to move are provided inside the shoulder support, the massage assembly has a massage head, and, when the massage head is in contact with a shoulder of an occupant, the driving assembly is able to drive the massage head to swing back and forth to simulate kneading massage.

With the above structure, the driving assembly drives the massage head to move in a reciprocating swinging manner, which can simulate a kneading massage on the occupant's shoulder, thereby effectively relieving fatigue experienced by the occupant's shoulder during prolonged sitting.

Preferably, the driving assembly comprises a transmission shaft that is able to rotate within the shoulder support, two ends of the transmission shaft are provided with annular grooves, the massage assembly comprises a massage swing arm, one end of the massage swing arm is rotatably fitted on the annular groove, and the other end thereof is connected to the massage head, side walls of the annular groove on two sides are both arranged to be inclined relative to a centreline of the transmission shaft, and two sides of the massage swing arm at an end close to the transmission shaft are in sliding contact with the side walls of the transmission shaft on the two sides, respectively; and, when the massage head is subjected to resistance from a seat cover or a user's shoulder, the transmission shaft rotates, and, under the transmission action of the inclined side walls of the annular groove, is able to force the massage swing arm to swing back and forth along an axial direction of the transmission shaft, so that the massage head at a distal end swings back and forth. With the above structure, the kneading massage of the occupant's shoulders can be realized, relieving the occupant's shoulder fatigue.

Preferably, the driving assembly further comprises an electric motor disposed at a middle position of the shoulder support, an output end of the electric motor is connected to a worm extending in a vertical direction, the worm is meshed with a worm wheel, and the worm wheel is fixedly sleeved on the transmission shaft. With the above structure, rotational power can be provided to the transmission shaft by means of worm and worm wheel transmission.

Preferably, a positioning wheel is fixedly provided inside the shoulder support, and the transmission shaft is rotatably supported inside the positioning wheel. With the above structure, the stable rotation of the transmission shaft can be ensured.

Preferably, eccentric wheels are fixedly provided at two ends of the transmission shaft, the annular grooves are provided on the eccentric wheels, the massage swing arm comprises annular portions rotatably mounted in the annular grooves and rod-shaped portions disposed at upper ends of the annular portions, an extending direction of the rod-shaped portion is consistent with an inclination direction of the annular groove, and the massage head is fixedly disposed at a front end position of a top portion of the rod-shaped portion. With the above structure, when the massage head is subjected to resistance from a seat cover or a user's shoulder, the transmission shaft rotates, and, under the transmission action of the inclined side walls of the annular groove, is able to force the annular portion and the rod-shaped portion to swing back and forth along an axial direction of the transmission shaft, so that the massage head at a distal end swings back and forth.

Preferably, a retraction control mechanism is mounted inside the shoulder support, and is configured to switch the massage head between protruding from a surface of the shoulder support and being retracted inside the shoulder support. With the above structure, it can be ensured that, when the shoulder kneading massage assembly is not in use, the occupant's shoulder will not feel any foreign body sensation against the shoulder support.

Preferably, the retraction control mechanism comprises a sliding block and a driving member for controlling the sliding block to reciprocate within the shoulder support, the sliding block is provided with a groove thereon, the annular portion is provided with a guide rod at one end away from the massage head, the guide rod is located within the groove, and the groove has a guiding slope on one side; when the sliding block moves to one side, the sliding block is able to drive the massage swing arm to swing forward under the transmission action of the guiding slope and the guide rod, and a first elastic element is connected between the massage swing arm and the shoulder support, and the first elastic element applies a rearward rotational pulling force to the massage swing arm. With the above structure, the movement of the sliding block, by means of the provided guiding slope, causes the guiding slope to move relative to the guide rod, thereby causing the massage swing arm to swing forward; the first elastic element provided is also able to apply a rearward pulling force to the massage swing arm in real time, ensuring that the shoulder support kneading massage device is always in a folded state when not in use.

Preferably, a shoulder support frame is provided inside the shoulder support, and both the massage assembly and the driving assembly are disposed on the shoulder support frame. With the above structure, it enables the massage assembly and the driving assembly to be more stably mounted.

A second objective of the present utility model is to provide a vehicle seat.

A vehicle seat comprising a seat back, characterized in that: the shoulder kneading massage device described above is integrated and mounted at a shoulder position of the seat back. With the above structure, it enables the vehicle seat to have a shoulder massage function, thereby effectively relieving fatigue experienced by the occupant's shoulders during prolonged sitting.

Preferably, the shoulder support is mounted at the shoulder position of the seat back in such a manner that the shoulder support is flippable forward and backward, a second elastic element is provided between the shoulder support and the seat back, the second elastic element applies a thrust to flip the shoulder support forward relative to the seat back, a driving mechanism is provided between the shoulder support and the seat back, the driving mechanism is configured to actively control the shoulder support to rotate and fold backward against the resistance of the second elastic element; and, when the shoulder support is in a forward-unfolded state, a thrust from an occupant's shoulder is able to force the shoulder support to passively rotate and fold backward against the resistance of the second elastic element. With the above structure, it can adapt to the needs of occupants with different body sizes for the shoulder support. When a vehicle is impacted, the thrust applied by the occupant's shoulder to the shoulder support can cause the shoulder support to actively collapse sequentially, thereby effectively reducing the impact force on the occupant's shoulder and ensuring the occupant's riding safety.

Compared with the prior art, the device has the following beneficial effects:
1. With the shoulder kneading massage device and the vehicle seat, the driving assembly drives the massage head to move in a reciprocating swinging manner, which can simulate kneading on the occupant's shoulders, thereby effectively relieving fatigue experienced by the occupant's shoulders.
2. With the massage device, the driving assembly drives the transmission shaft to rotate and transmits the power to the massage swing arm. Since the massage head at the distal end of the massage swing arm is subjected to the resistance of the seat cover or the user's shoulder, and the inclined cam transmission is formed between the inclined side wall of the annular groove and the side wall of the massage swing arm, the rotation of the transmission shaft can force the massage swing arm to swing back and forth along an axial direction of the transmission shaft. That is, the massage swing arm can swing left and right, so that the massage head at the distal end forms a reciprocating swinging kneading massage on the user's back, thereby having the advantages of good massage effect and simple structure.
3. By means of the driving assembly driving the sliding block to move and the pulling force of the first elastic element, the massage swing arm can be forced to rotate, thereby enabling the massage head to unfold forward and fold backward. The overall operation is very simple. In addition, by folding the massage head, it can also be ensured that the shoulder support kneading massage device will not make the occupant feel any foreign object sensation when not in use.

### BRIEF DESCRIPTION OF THE DRAWINGS

FIG. 1 is a schematic structural view of a vehicle seat;

FIG. 2 is a schematic structural view of a shoulder support frame 2;

FIG. 3 is a schematic structural view of installation positions of a massage assembly A and a driving assembly B;

FIG. 4 is a schematic structural view of a transmission component B;

FIG. 5 is a schematic structural view of a transmission shaft 7;

FIG. 6 is a schematic structural view of a massage assembly A;

FIG. 7 is a schematic structural view of a retraction control mechanism C;

FIG. 8 is a schematic structural view of a massage head 3 in a folded state;

FIG. 9 is a left view of FIG. 8;

FIG. 10 is a schematic structural view of a massage head 3 in an unfolded state;

FIG. 11 is a left view of FIG. 10;

FIG. 12 is a side sectional view of a shoulder support 1 in a folded state (with a headrest hidden);

FIG. 13 is a side sectional view of a shoulder support 1 in a forward-rotated, unfolded state (with a headrest hidden);

FIG. 14 is a side sectional view of a shoulder support 1 in a backward collapsed state (with a headrest hidden); and

FIG. 15 is a reference view of an actual use state of a shoulder support 1 in a backward-rotated, unfolded state.

### DETAILED DESCRIPTION

The device will be further described below with reference to the embodiments and drawings.

### Embodiment 1:

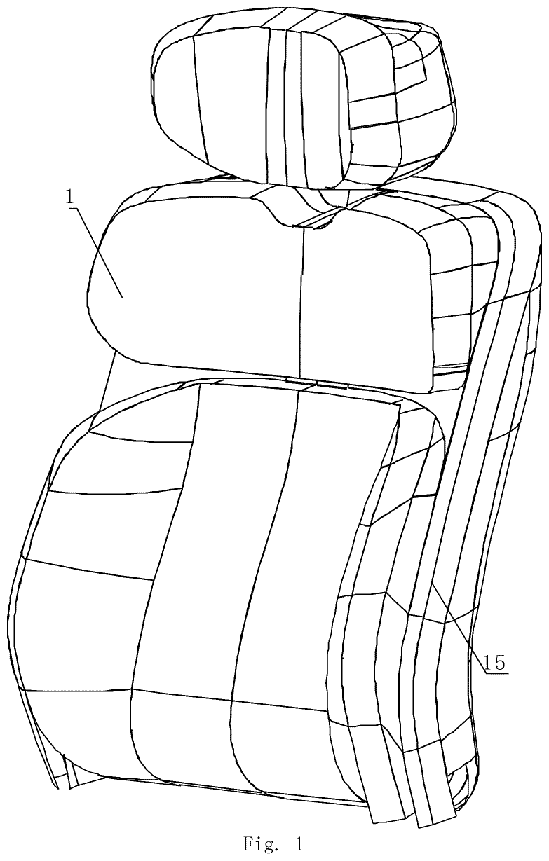

As shown in FIGS. 1 to 3, a shoulder kneading massage device comprises a shoulder support 1 mounted at a shoulder position of a seat back 15. A massage assembly A and a driving assembly B for driving the massage assembly A to move are provided inside the shoulder support 1, wherein the massage assembly A comprises a massage head 3, the massage head 3 is configured to fit a shoulder of an occupant, and the operation of the driving assembly B can drive the massage head 3 to move in a reciprocating swinging manner.

With such a design, the massage head 3 is driven by the massage assembly A to swing back and forth, which can simulate a kneading action, thereby implementing a kneading massage on the occupant's shoulder and effectively relieving the occupant's shoulder fatigue.

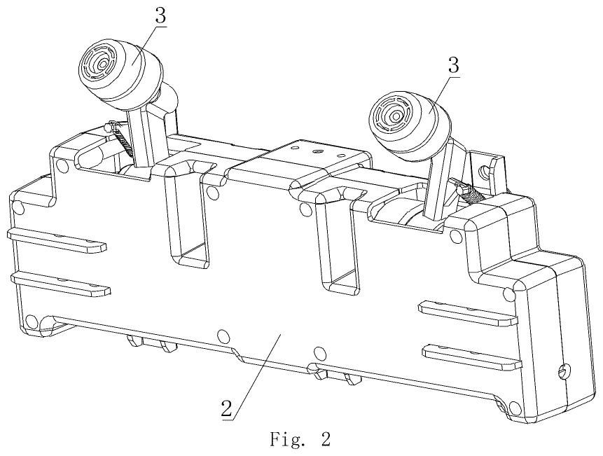

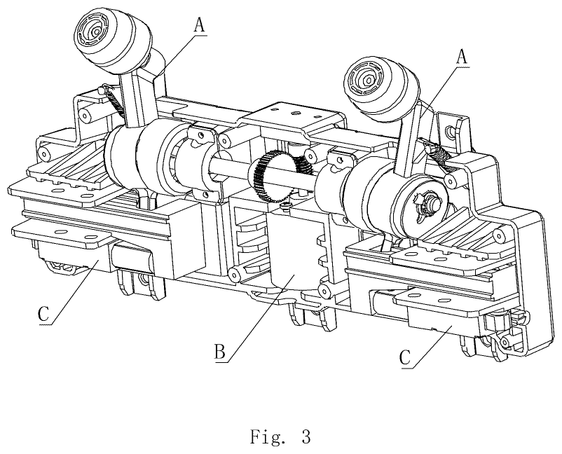

As shown in FIGS. 2 and 3, in this embodiment, a shoulder support frame 2 is integrated inside the shoulder support 1, and both the massage assembly A and the driving assembly B are mounted on the shoulder support frame 2, thereby ensuring that the structure of the shoulder kneading massage device is more stable.

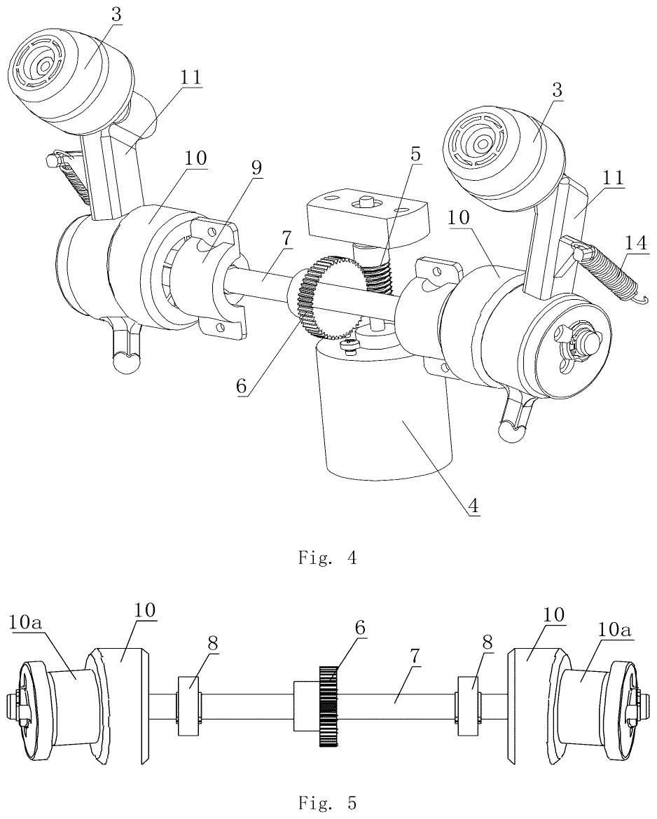

Specifically, as shown in FIGS. 3 to 5, the driving assembly B comprises a transmission shaft 7 that can rotate within the shoulder support frame 2. The transmission shaft 7 is arranged along the length direction of the shoulder support frame 2, and annular grooves 10a are provided at two ends of the transmission shaft 7. The massage assembly A comprises a massage swing arm 11. One end of the massage swing arm 11 is rotatably fitted on the annular groove 10a, and the other end thereof is connected to a massage head 3. The side walls of the annular groove 10a on two sides are arranged to be inclined relative to the centreline of the transmission shaft 7. In this embodiment, when the shoulder kneading device is not in use, the annular grooves 10a are each inclined toward the middle portion of the lower end of the shoulder support frame 2, and the two sides of the massage swing arm 11 at one end close to the transmission shaft 7 are in sliding contact with the side walls of the transmission shaft 7 on the two sides, respectively. The rotation of the transmission shaft 7 can drive the annular groove 10a to rotate synchronously. The movement trajectory of the annular groove 10a is a wave-like shape that swings back and forth in a vertical plane. Since the massage head 3 is affected by the resistance from the shoulder support cover or the occupant's shoulder, under the transmission action of the inclined side walls of the annular grooves 10a, the massage swing arm 11 is forced to reciprocate along an axial direction of the transmission shaft 7, so that the massage head 3 at the distal end swings back and forth, thereby simulating the kneading massage on the occupant's shoulder and relieving the occupant's shoulder fatigue.

Furthermore, the driving assembly B further comprises an electric motor 4 fixedly mounted at a middle position of the interior of the shoulder support frame 2. An output end of the electric motor 4 is connected to a worm 5 extending in a vertical direction. The worm 5 is meshed with a worm wheel 6, and the worm wheel 6 is fixedly sleeved on the transmission shaft 7. With such a design, the power transmission is converted from longitudinal transmission to horizontal transmission, greatly reducing the overall thickness of the shoulder support 1.

In this embodiment, positioning wheels 8 are further fixedly mounted inside the shoulder support frame 2 by means of a positioning sleeve 9. Two positioning wheels 8 are provided, and the two positioning wheels 8 are symmetrically distributed on the left and right sides of the worm wheel 6. The transmission shaft 7 is rotatably supported inside the positioning wheels 8. With such a design, it can be ensured that the worm wheel 6 and the worm 5 can be stably meshed for transmission.

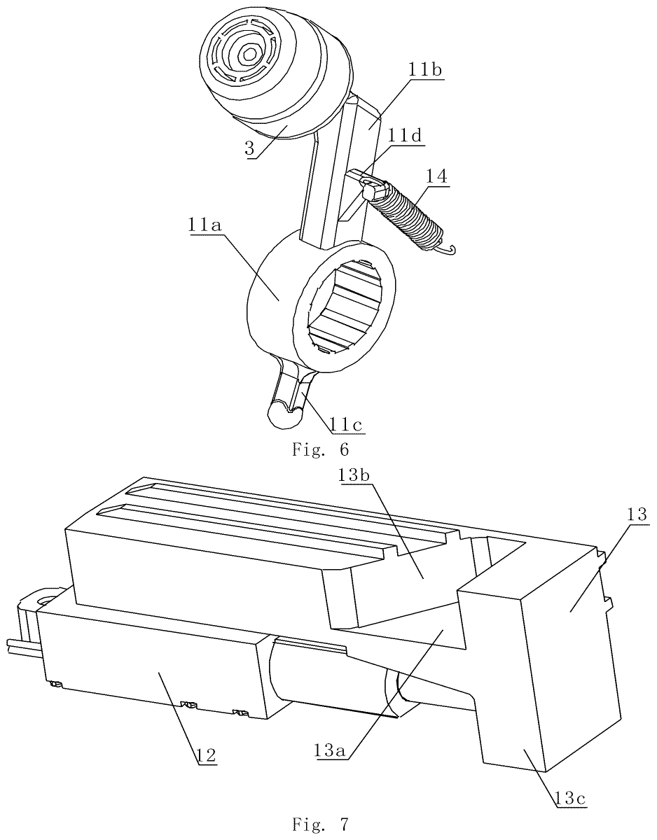

As shown in FIGS. 5 and 6 again, eccentric wheels 10 are fixedly mounted at two ends of the transmission shaft 7, and annular grooves 10a are formed on the eccentric wheels 10. The massage swing arm 11 comprises annular portions 11a rotatably mounted in the annular grooves 10a, and rod-shaped portions 11b disposed at the upper ends of the annular portions 11a. The extending direction of the rod-shaped portion 11b is consistent with the inclination direction of the annular groove 10a. The massage head 3 is fixedly mounted at the front end position of the top portion of the rod-shaped portion 11b. With such a design, it can be ensured that, when the massage assembly A is not in use, the massage head 3 is in a folded-back state.

As shown in FIG. 3, a retraction control mechanism C is further mounted inside the shoulder support 1. The retraction control mechanism C is configured to switch the massage head 3 between protruding from the surface of the shoulder support 1 and being folded into the interior of the shoulder support 1.

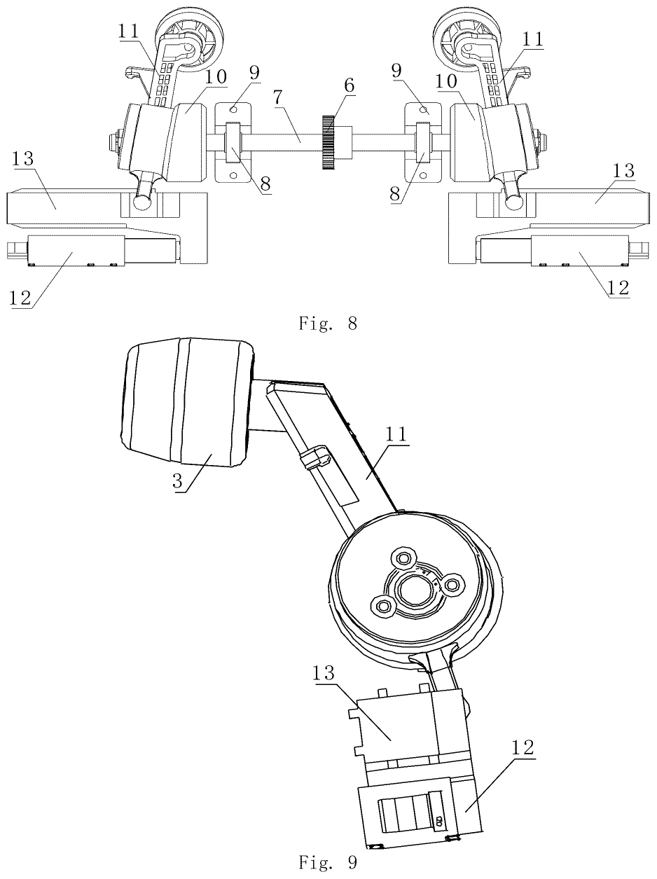

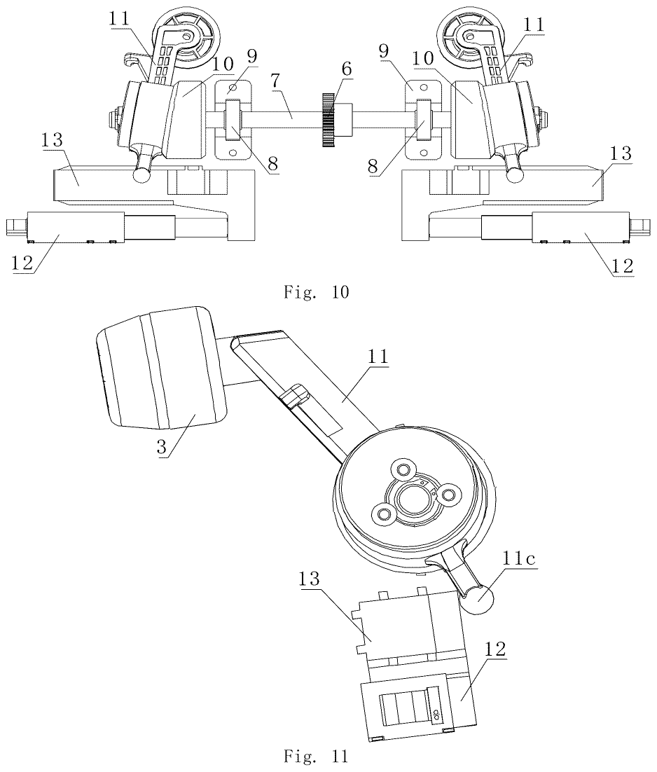

Specifically, as shown in FIGS. 7 to 11, the contraction control mechanism C comprises a sliding block 13 and a driving assembly 12 that controls the reciprocating movement of the sliding block 13 within the shoulder support frame 2. In this embodiment, the driving assembly 12 may be a cylinder or a lead screw motor. A groove 13a is formed on the top portion of the sliding block 13, and a guide rod 11c is formed at the end of the annular portion 11a away from the massage head 3. The guide rod 11c is located within the groove 13a, and a guiding slope 13b is provided on one side of the groove 13a. In this embodiment, the sliding block 13 has a long strip structure and is arranged parallel to the transmission shaft 7. The groove 13a is provided at one end close to the annular groove 10a, and the guiding slope 13b extends toward the rear end of the outside of the shoulder support frame 2. A downwardly extending mounting block 13c is formed on the sliding block 13. The output end of the driving member 12 is fixedly connected to the mounting block 13c. When the driving member 12 drives the sliding block 13 to move toward the middle position of the shoulder support frame 2, the transmission action of the guiding slope 13b and the guide rod 11c enables the massage swing arm 11 to swing forward, thereby unfolding the massage assembly A forward. A hook portion 11d extends outward from the side portion of the rod-shaped portion 11b. The hook portion 11d and the rear end of the shoulder support frame 2 are connected to a first elastic element 14. In this embodiment, the first elastic element 14 is a tension spring, and the tension spring can continuously apply a rearward pulling force to the massage swing arm 11. With such a design, it can be ensured that the shoulder support kneading massage device can be stably folded when not in use, thereby avoiding foreign body sensation for the occupant to affect riding comfort. In addition, when the use of the shoulder support kneading massage device is finished, the guide rod 11c can rely on the pulling force of the first elastic element 14 to abut against the groove 13a again, thereby completing the folding of the massage assembly A.

In conjunction with the above structure, the specific working principle of the shoulder kneading massage device is as follows:
When the shoulder kneading massage device is not in use, the massage swing arm 11 is affected by the pulling force of the first elastic element 14 to be in the folded-back state, and the guide rod 11c is located in the groove 13a. When the shoulder kneading massage device needs to be used, the driving assembly 12 drives the sliding block 13 to slide toward the middle position of the shoulder support frame 2. At this time, under the transmission action of the guiding slope 13b and the guide rod 11c, the massage swing arm 11 can rotate forward as a whole, and the massage head 3 can be pressed against the shoulder support cover. Then, the electric motor 4 runs, and the power is transmitted through the worm wheel 6 and the worm 5, causing the transmission shaft 7 to rotate. The massage head 3 is blocked by the seat cover and the occupant's shoulder, and cannot rotate forward synchronously. Under the transmission action of the inclined side walls of the annular groove 10a, the massage head can be driven to swing back and forth along the axial direction of the transmission shaft 7, thereby simulating a kneading massage on the occupant's shoulder and effectively relieving the occupant's shoulder fatigue. When the use of the shoulder kneading massage device is finished, the driving assembly 12 drives the sliding block 13 to slide toward the side portion of the shoulder support frame 2. Under the pulling force applied by the first elastic element 14, the upper end of the massage swing arm 11 rotates backward, thereby causing the massage head 3 to fold. The guide rod 11c is affected by the rotational force of the massage swing arm 11 to abut against the groove 13a again.

### Embodiment 2:

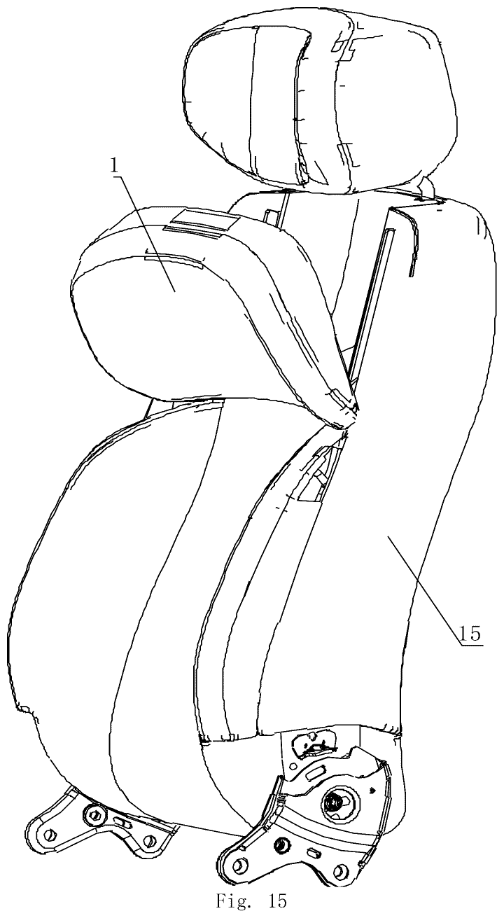

As shown in FIG. 15, a vehicle seat comprises a seat back 15, and the shoulder kneading massage device described in Embodiment 1 is integrated and mounted at a shoulder position of the seat back 15.

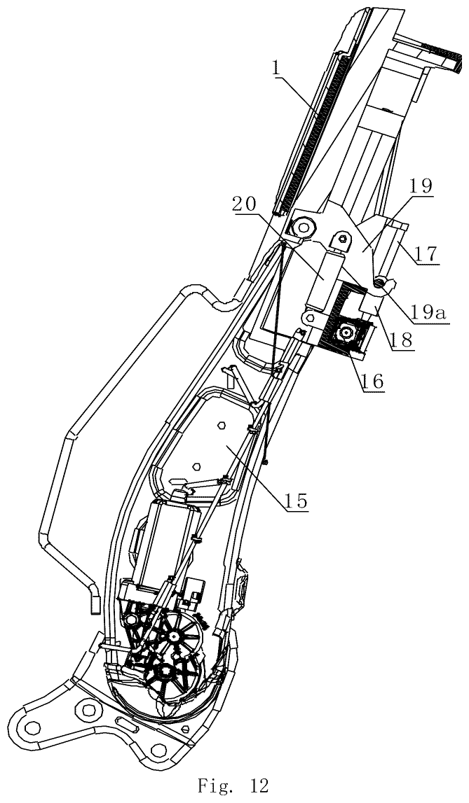

As shown in FIGS. 12 to 14, the shoulder support 1 is mounted at the shoulder position of the seat back 15 in such a manner that the shoulder support is flippable forward and backward. A second elastic element 20 is mounted between the shoulder support 1 and the seat back 15. The second elastic element 20 applies a thrust that causes the shoulder support 1 to flip forward relative to the seat back 15. A driving mechanism is further mounted between the shoulder support 1 and the seat back 15. The driving mechanism is configured to actively control the shoulder support 1 to rotate and fold backward against the resistance of the second elastic element 20. When the shoulder support 1 is in a forward-unfolded state, the thrust from an occupant's shoulder can force the shoulder support 1 to passively rotate and fold backward against the resistance of the second elastic element 20.

Specifically, the driving mechanism comprises a driving electric motor 16 fixedly mounted at the rear end of the seat back 15. A lead screw 17 is mounted at an output end of the driving electric motor 16. The lead screw 17 is arranged along the length direction of the seat back 15. A moving block 18 is threaded onto the lead screw 17. Two sides of the lower end of the shoulder support 1 are rotatably mounted on the seat back 15, and a rearwardly extending swing arm 19 is fixedly mounted on the shoulder support 1. A locking groove 19a is formed in the swing arm 19. The locking groove 19a is open upward, and the underside of an end of the moving block 18 abuts against the locking groove 19a. The second elastic element 20 is a pneumatic spring, two ends of which are rotatably mounted on the middle of the swing arm 19 and the base of the driving electric motor 16, respectively.

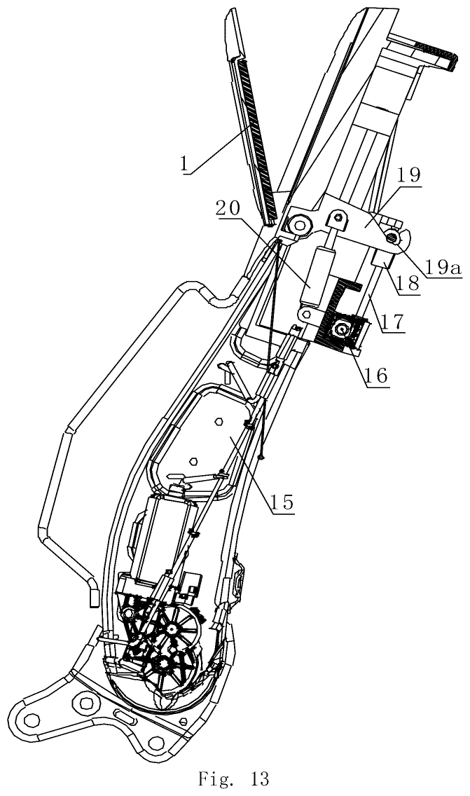

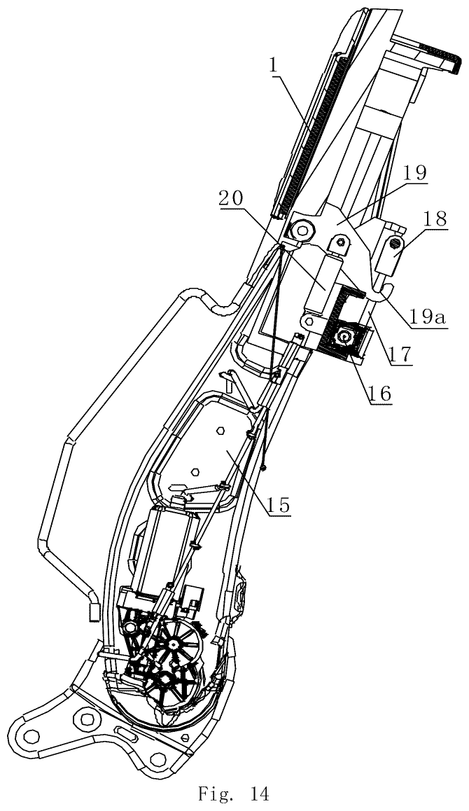

With reference to FIGS. 12 and 13, when the vehicle seat is not in use, the moving block 18 is at the lowest end of the lead screw 17, and, by means of the swing arm 19, the second elastic element 20 is caused to be in a stored state. When the driving electric motor 16 runs and drives the moving block 18 to move upward along the lead screw 17, the second elastic element 20 can release the force upward, thereby pushing the swing arm 19 to move upward, so that the shoulder support 1 rotates forward to meet the needs of occupants with different body sizes for the shoulder support 1. Throughout the process, the locking groove 19a always abuts against the underside of the end of the moving block 18. With reference to FIG. 14 again, when the shoulder support 1 is in the forward-unfolded state, the thrust from the occupant's shoulder forces the swing arm 19 to move downward against the upward thrust of the second elastic element 20. The locking groove 19a moves downward and separates from the moving block 18, thereby causing the shoulder support 1 to passively fold backward. With this design, when a vehicle is subjected to a collision, the shoulder support 1 can collapse backward to reduce the impact force on the occupant's shoulder. The pneumatic spring 20 further reduces the impact force on the occupant, ensuring the occupant's safety. During the entire collapse process, no force is applied to the moving block 18, thereby ensuring that the lead screw 17 is not damaged, and ensuring the service life of the entire driving mechanism.

Finally, it should be noted that only preferred embodiments have been described above. Those of ordinary skill in the art can make various similar expressions without departing from the spirit and claims, and such changes all fall within the scope of protection.

What is claimed is:

1. A shoulder kneading massage device, comprising a shoulder support configured to be disposed at a shoulder position of a seat back, characterized in that: a massage assembly and a driving assembly for driving the massage assembly to move are provided inside the shoulder support, the massage assembly has a massage head, and, when the massage head is in contact with a shoulder of an occupant, the driving assembly is able to drive the massage head to swing back and forth to simulate kneading massage.

2. The shoulder kneading massage device according to claim 1, characterized in that: the driving assembly comprises a transmission shaft that is able to rotate within the shoulder support, two ends of the transmission shaft are provided with annular grooves, the massage assembly comprises a massage swing arm, one end of the massage swing arm is rotatably fitted on the annular groove, and the other end thereof is connected to the massage head, side walls of the annular groove on two sides are both arranged to be inclined relative to a centreline of the transmission shaft, and two sides of the massage swing arm at an end close to the transmission shaft are in sliding contact with the side walls of the transmission shaft on the two sides, respectively;
when the massage head is subjected to resistance from a seat cover or a user's shoulder, the transmission shaft rotates, and, under the transmission action of the inclined side walls of the annular groove, is able to force the massage swing arm to swing back and forth along an axial direction of the transmission shaft, so that the massage head at a distal end swings back and forth.

3. The shoulder kneading massage device according to claim 2, characterized in that: the driving assembly further comprises an electric motor disposed at a middle position of the shoulder support, an output end of the electric motor is connected to a worm extending in a vertical direction, the worm is meshed with a worm wheel, and the worm wheel is fixedly sleeved on the transmission shaft.

4. The shoulder kneading massage device according to claim 2, characterized in that: a positioning wheel is fixedly provided inside the shoulder support, and the transmission shaft is rotatably supported inside the positioning wheel.

5. The shoulder kneading massage device according to claim 2, characterized in that: eccentric wheels are fixedly provided at two ends of the transmission shaft, the annular grooves are provided on the eccentric wheels, the massage swing arm comprises annular portions rotatably mounted in the annular grooves and rod-shaped portions disposed at upper ends of the annular portions, an extending direction of the rod-shaped portion is consistent with an inclination direction of the annular groove, and the massage head is fixedly disposed at a front end position of a top portion of the rod-shaped portion.

6. The shoulder kneading massage device according to claim 5, characterized in that: a retraction control mechanism is mounted inside the shoulder support, and is configured to switch the massage head between protruding from a surface of the shoulder support and being retracted inside the shoulder support.

7. The shoulder kneading massage device according to claim 6, characterized in that: the retraction control mechanism comprises a sliding block and a driving member for controlling the sliding block to reciprocate within the shoulder support, the sliding block is provided with a groove thereon, the annular portion is provided with a guide rod at one end away from the massage head, the guide rod is located within the groove, and the groove has a guiding slope on one side; when the sliding block moves to one side, the sliding block is able to drive the massage swing arm to swing forward under the transmission action of the guiding slope and the guide rod, and a first elastic element is connected between the massage swing arm and the shoulder support, and the first elastic element applies a rearward rotational pulling force to the massage swing arm.

8. The shoulder kneading massage device according to claim 1, characterized in that: a shoulder support frame is provided inside the shoulder support, and both the massage assembly and the driving assembly are disposed on the shoulder support frame.

9. A vehicle seat comprising a seat back, characterized in that: the shoulder kneading massage device according to claim 1 is integrated and mounted at a shoulder position of the seat back.

10. The vehicle seat according to claim 9, characterized in that: the shoulder support is mounted at the shoulder position of the seat back in such a manner that the shoulder support is flippable forward and backward, a second elastic element is provided between the shoulder support and the seat back, the second elastic element applies a thrust to flip the shoulder support forward relative to the seat back, a driving mechanism is provided between the shoulder support and the seat back, the driving mechanism is configured to actively control the shoulder support to rotate and fold backward against the resistance of the second elastic element;
when the shoulder support is in a forward-unfolded state, a thrust from an occupant's shoulder is able to force the shoulder support to passively rotate and fold backward against the resistance of the second elastic element.
